(19) United States
(12) Patent Application Publication
(10) Pub. No.: US 2015/0294320 A1
(43) Pub. Date: Oct. 15, 2015

(54) Method for Determining if a Used Electronic Device Belongs to a User

(71) Applicants: Tu Nguyen, Fremont, CA (US); Qui Nguyen Thach, Ho Chi Minh City (VN); Nghia Huu Nguyen, Ho Chi Minh City (VN)

(72) Inventors: Tu Nguyen, Fremont, CA (US); Qui Nguyen Thach, Ho Chi Minh City (VN); Nghia Huu Nguyen, Ho Chi Minh City (VN)

(21) Appl. No.: 14/492,048

(22) Filed: Sep. 21, 2014

Related U.S. Application Data
(60) Provisional application No. 61/979,703, filed on Apr. 15, 2014.

(51) Int. Cl. G06Q 30/00; H04W 12/12; H04W 12/06

(52) U.S. Cl. CPC G06Q 30/0185; H04W 12/06; H04W 12/12

(57) ABSTRACT

A method for determining whether a used electronic device has theft-detection software turned on. Such a method may be used at a repurchase facility or an automated kiosk to reject devices that may be stolen.

### CROSS-REFERENCE TO RELATED APPLICATIONS

The present application takes priority from Provisional Application No. 61/979,703, filed on Apr. 15, 2014, which is incorporated herein by reference.

### STATEMENT REGARDING FEDERALLY SPONSORED RESEARCH AND DEVELOPMENT

Not Applicable.

### BACKGROUND

1. Field of the Invention

The present invention relates generally to recycling electronics, and more specifically, to a method for easily determining whether a used electronic device has theft-prevention software turned on.

2. Description of the Related Art

Due to the rapid evolution of electronic devices, consumers often have an excess of old, unwanted electronic devices cluttering up their homes. Such devices may include cell phones, PDA's, smartphones, GPS devices, calculators, mp3 players, and other similar electronics. While such devices may be worth money, it is often complicated to sell the devices, and too many of them end up thrown away. When thrown away, these devices contaminate the waste stream, due to their heavy metal content. This is a serious hazard to the environment. Making resale facilities more widely available is therefore desirable.

Many smartphones and other electronic devices have security software built in to deter theft. Since thieves often want to resell the electronic devices they steal, it may be helpful to detect a potential thief at the resale facility or recycling kiosk, so that the thief may be apprehended and the stolen property may be recovered. This reduces the potential liability that a resale facility may be exposed to, and makes it easier to operate such a facility without running afoul of the law or encouraging theft. However, most device manufacturers and cell phone carriers do not make it very easy to determine whether a device is stolen.

This is an especially serious problem for automated recycling kiosks, where a human being is not available to tell whether a potential reseller has shifty eyes or looks shady. As a result, some municipalities have banned electronics recycling kiosks altogether, arguing that it encourages theft.

A need therefore exists for an easy way for a resale facility, an automated kiosk, or a recycler, to detect devices that may potentially be stolen property.

### SUMMARY OF THE INVENTION

An object of the present invention is to enable a recycler, refurbisher, or automated recycling kiosk to tell whether or not a used electronic device is stolen.

Another object of the present invention is to deter thieves from using automated recycling kiosks and other electronics resale facilities.

In its preferred embodiment, the method of the present invention comprises connecting to a used electronic device and sending a command to it to request information that is normally restricted by anti-theft technology. Such information may be the user's name or any other information. If the device does not provide this information in response to the command, the user is asked to turn off the anti-theft technology on the device. If the user cannot turn off the anti-theft technology, the device is assumed to be stolen property.

In another embodiment of the present invention, the information normally restricted by anti-theft technology is requested from a service provider such as a cell phone company. Similarly to the above embodiment, if the service provider does not provide this information, the user is asked to turn off the anti-theft technology on the device; if the user cannot do so, the device is assumed to be stolen.

The anti-theft technology can be any software installed on an electronic device to lock it, deter thieves, or enable the rightful owner to find the device. For example, Find My iPhone enables a rightful owner to find their iPhone or to prevent a thief from using the device.

Since it is impossible to receive a direct answer from the manufacturer whether or not Find My iPhone is turned on in any particular iPhone, an indirect method of accessing this information is desired. In an embodiment of the present invention, the method comprises contacting the manufacturer of the iPhone to report a problem with the iPhone, giving the device ID of the iPhone at issue. The answer that is received will provide a clue as to whether Find My iPhone is turned on; for example, the manufacturer's response may be “Turn off Find My iPhone”. The automated kiosk, recycling facility, or reseller may then be able to determine whether Find My iPhone is turned on, ask the user to turn it off, and if the user cannot turn it off, reject the device.

An automated kiosk can use the method of the present invention to detect devices that may possibly be stolen. Such a kiosk may perform the analysis described above when a used electronic device is offered for resale. Thus, the kiosk would connect to the used electronic device, query the device or the service provider associated with the device for information that is normally restricted by anti-theft technology (the user's name or other information), and if the device fails to provide this information, ask the user to turn off the anti-theft technology. If the user cannot turn off the anti-theft technology, the kiosk rejects the device.

The method of the present invention can also be used at a retail counter. A retail clerk could plug a used electronic device into a computer or a dedicated device for electronic device analysis. The computer or dedicated device could query the used electronic device and request information that is normally blocked by anti-theft technology, such as the user's name. If the used electronic device does not provide this information, the store clerk could request that the user turn off anti-theft technology on their device. If the user cannot turn off the anti-theft technology, the store clerk can reject the device.

The method of the present invention can also be used at the test floor in a recycling or refurbishing facility. Since a device with active anti-theft software installed cannot be refurbished the same way a device without such software can be, it is important to sort out the devices with active anti-theft software installed so that they can be sent back, or so that they can be recycled for their materials content (since they cannot be refurbished). The devices can then all be queried in a similar way as described above by a dedicated device or a computer.

If the method of the present invention is used in a kiosk, the kiosk can take further steps if a device is determined to have been stolen. The kiosk can take a picture or video of the user, contact law enforcement, or sound an alarm.

### LIST OF FIGURES

FIG. 1 shows a diagram of the preferred embodiment of the method of the present invention.

### DETAILED DESCRIPTION OF THE PREFERRED EMBODIMENT

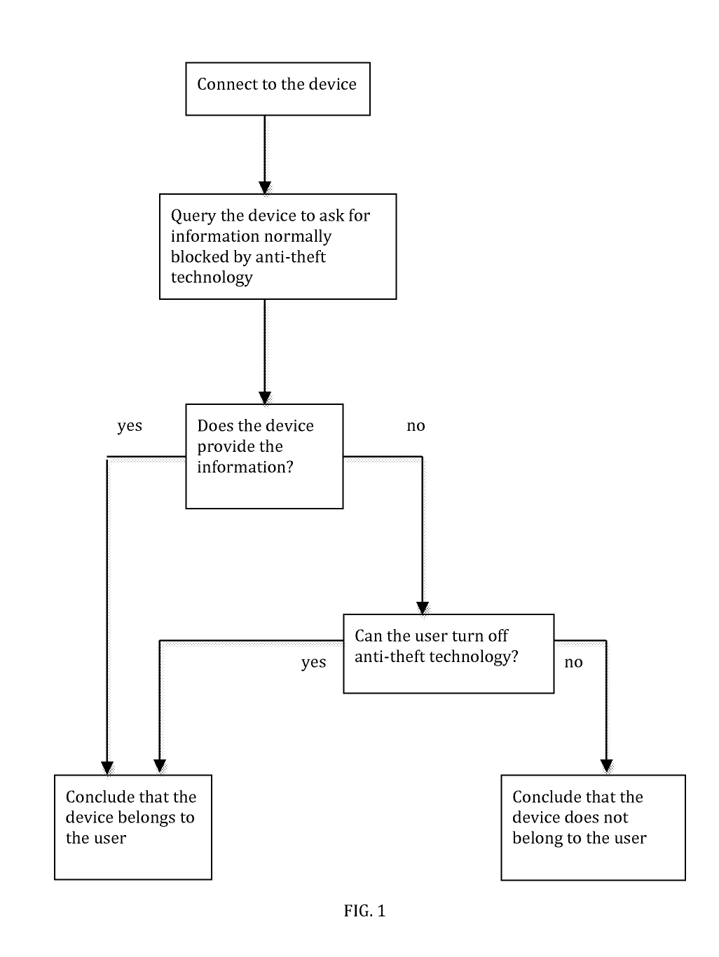

FIG. 1 shows a diagram of the method of the present invention. The method of the present invention may be practiced by means of a computer, a processor built into a kiosk or a testing device, or a mobile device capable of running software. For purposes of the disclosure, the machine responsible for carrying out the steps of the method of the present invention will be referred to as the “testing device”.

As can be seen in the Figure, the first step is to connect to the used electronic device. The connection can happen via a cable or wirelessly, by wi-fi, Bluetooth, or cellular data connection. The testing device may also connect to several used electronic devices at the same time if needed - for example, on the factory floor.

The testing device then queries the used electronic device. In an embodiment, it may determine the device ID of the used electronic device prior to querying it. The query the testing device sends to the used electronic device preferably comprises a request for information normally blocked by anti-theft technology. For purposes of the present disclosure, “anti-theft technology” refers to software such as “Find My iPhone” or other software that performs a similar function for other operating systems.

The query the testing device sends to the used electronic device comprises a request for information normally blocked by anti-theft technology. Such information may include the user's name, the user's fingerprint data, the user's email address, and so on. Other information blocked by anti-theft technology may also be requested in such a query.

If the used electronic device provides the requested information, the testing device concludes that the used electronic device belongs to the user and no further inquiry is made. If the used electronic device does not provide the requested information, the testing device concludes that anti-theft technology is turned on. In a testing device on the factory floor in a refurbishing facility, the testing device may not perform any further functions on the device - since the user is not present and cannot turn off the anti-theft technology, there is no way to refurbish the device and it needs to be sent back. Such devices may be labeled accordingly so that they can be identified by the recycling or refurbishing facility. Alternately, devices with anti-theft technology turned on may be recycled for their raw materials, reformatted, or processed in some other way that does not involve erasure of data or refurbishing of the device.

In an application where the user is present, the testing device may prompt the user to turn off the anti-theft technology on their device. For example, an automated kiosk for the resale and recycling of used electronic devices, or a retail counter-top machine that assists a clerk in repurchasing used electronic devices, are applications where the user is present with their device. In such applications, the user may be prompted to turn off the anti-theft technology.

If the user can turn off the anti-theft technology, the used electronic device is accepted for resale. It may then be sent to a refurbishing facility, since the anti-theft technology is turned off and the used electronic device may be processed and refurbished easily.

If the user cannot turn off the anti-theft technology, the used electronic device is rejected. Such a used electronic device would not be able to be refurbished, and therefore it would not be worth as much as a used electronic device without anti-theft technology; it would therefore make no economic sense for the reseller to purchase such a device. Also, purchasing such a device would encourage theft.

In an embodiment, the testing device sounds an alarm, takes a picture or video of the user, or alerts the authorities when a used electronic device is rejected in the above fashion. This would further deter thieves from reselling stolen devices.

In an embodiment, the testing device queries the cellular service provider instead of querying the used electronic device itself. In that embodiment, the testing device finds out the device ID of the used electronic device and uses the device ID to query the cellular service provider and request information regarding the device that would normally be blocked by anti-theft technology. If the cellular service provider does not provide this information, the testing device then asks the consumer to turn off the anti-theft technology; if the consumer cannot turn it off, the used electronic device is rejected.

In another embodiment, the testing device queries the manufacturer of the used electronic device. For example, the testing device may contact Apple for any iPhone or any other used electronic device manufactured by Apple, using the device ID to request information regarding the device that would normally be blocked by anti-theft technology. If the manufacturer does not provide this information, the testing device then asks the consumer to turn off the anti-theft technology. If the consumer cannot turn it off, the used electronic device is rejected.

Since Apple is often reluctant to provide direct answers as to whether “Find My iPhone” is turned on for a particular device, an indirect method of deriving this information is often needed. In an embodiment of the present invention specifically pertaining to devices manufactured by Apple (such as the iPhone, iPad, iPod, and so on), the testing device first determines the device ID of the used electronic device, and then contacts Apple to report a problem with the used electronic device. The response from Apple may contain information that gives a clue as to whether Find My iPhone is turned on in the device; for example, the response may be “Turn off Find My iPhone”. The testing device then uses the response from Apple to conclude that Find My iPhone is turned on, and requests that the user turn off the app. If the user cannot turn off Find My iPhone, the testing device concludes that the used electronic device does not belong to the user.

The method of the present invention may be implemented in a wide variety of devices. For example, the method of the present invention may be implemented in an automated kiosk for recycling used electronic devices. Such an automated kiosk would connect to a used electronic device and perform the steps of the method to make sure that the device is not stolen. If the conclusion is that the used electronic device does not belong to the user, the kiosk rejects the device and possibly also performs other steps such as sounding an alarm, taking a photo of the user, contacting law enforcement, and so on.

The method of the present invention may also be implemented in an electronics-evaluation device for a retail setting. Such an electronics-evaluation device may be a small desktop unit that is used by a retail clerk when buying back a used electronic device. The retail clerk would connect a used electronic device to the desktop unit, and the desktop unit would perform the steps of the method of the present invention to determine whether or not the used electronic device belongs to the user. If the conclusion is that the used electronic device does not belong to the user, the desktop unit can alert the retail clerk so that he or she can take appropriate steps (reject the device, alert store management, alert security, and so on).

The method of the present invention may also be implemented in an electronics-refurbishing facility on the factory floor. Such a facility typically receives large amounts of used electronic devices, not all of which may be refurbished, due to the presence of anti-theft software installed on them. In such a setting, since the user is not easy to reach, the facility may simply want to know whether the device has anti-theft software installed, so that such devices can be appropriately marked and slated for recycling (since they cannot be erased and refurbished). It can then use the first step of the method of the present invention to determine whether the device has anti-theft software installed.

Exemplary embodiments have been described above. Other embodiments of the invention are also apparent to someone of reasonable skill in the art, and are described below in the appended claims.

1. A method for detecting if a used electronic device belongs to a user, comprising:
connecting to the electronic device;
sending a command to the electronic device to request information normally restricted by anti-theft technology;
if the device does not provide the information, prompting the user to turn off theft-detection software;
if the user cannot turn off theft-detection software, concluding that the used electronic device does not belong to a user.

2. A method for detecting if a used electronic device, said electronic device associated with a service provider, belongs to a user, comprising:
connecting to the electronic device to determine the device ID of the electronic device;
sending a command to the service provider to request information normally restricted by anti-theft technology;
if the service provider does not provide the information, prompting the user to turn off theft-detection software;
if the user cannot turn off theft-detection software, concluding that the used electronic device does not belong to a user.

3. The method of claim 1, where the used electronic device is running the iOS operating system and the theft-detection software is Find My iPhone.

4. A method for detecting if a used iPhone has Find My iPhone turned on, comprising:
connecting to the iPhone;
sending a command to the iPhone to determine the device ID of the phone;
contacting the manufacturer of the iPhone to report an issue with the iPhone, and receiving an answer;
analyzing the manufacturer's answer to determine whether or not FindMylphone is turned on.

5. A method of repurchasing a used iPhone, comprising:
detecting if the used iPhone has FindMylphone turned on, according to claim 4;
rejecting the used iPhone if FindMylphone is turned on;
repurchasing the used iPhone if FindMylphone is not turned on.

6. A method of repurchasing a used electronic device from a user, comprising:
connecting to the used electronic device;
determining if the used electronic device belongs to the user according to the method of claim 1;
rejecting the device if it cannot be determined that the used electronic device belongs to the user;
repurchasing the device if it can be determined that the used electronic device belongs to the user.

7. A method of determining on a test floor if a used electronic device has theft-detection software turned on, comprising:
connecting to the used electronic device;
determining if the used electronic device belongs to the user according to the method of claim 1;
labeling the device accordingly if it cannot be determined that the used electronic device belongs to the user.

8. A method of determining at a retail counter if a used electronic device has theft-detection software turned on, comprising:
connecting to the used electronic device;
determining if the used electronic device belongs to the user according to the method of claim 1;
rejecting the used electronic device if it cannot be determined that the used electronic device belongs to the user.

9. A method of repurchasing a used electronic device at a kiosk from a user, comprising:
connecting the kiosk to the used electronic device;
using the kiosk to determine if the used electronic device belongs to the user according to the method of claim 1;
rejecting the device if it cannot be determined that the used electronic device belongs to the user;
using the kiosk to repurchase the device if it can be determined that the used electronic device belongs to the user.

10. The method of claim 9, further comprising:
if it cannot be determined that the used electronic device belongs to a user, performing one or more of the following group of actions:
sounding an alarm;
contacting law enforcement;
taking a picture of the user;
taking a video of the user.
